(19) United States
(12) Patent Application Publication
(10) Pub. No.: US 2009/0214165 A1
(43) Pub. Date: Aug. 27, 2009

(54) Optical Fiber Connector With Lens

(75) Inventors: Akihiro Shimotsu, Kanagawa (JP); Teruki Nagase, Kanagawa (JP); Tsuneyasu Asada, Kanagawa (JP)

Correspondence Address: MOLEX INCORPORATED, 2222 WELLINGTON COURT, LISLE, IL, 60532, US

(73) Assignee: MOLEX INCORPORATED, Lisle, IL (US)

(21) Appl. No.: 11/886,821

(22) PCT Filed: Mar. 24, 2006
(86) PCT No.: PCT/US2006/010562

§ 371 Date: Dec. 22, 2008

(30) Foreign Application Priority Data
Mar. 30, 2005 (JP) 2005-096954

(51) Int. Cl. G02B 6/36

(52) U.S. Cl. 385/79

(57) ABSTRACT

An optical connector having a compression ring that is fitted onto a front end portion of a ferrule so as to compressively deform the ferrule and thus reduce the diameter of a through hole formed in the ferrule to thereby press and fixedly hold an optical fiber within the through hole from the outside. The compression ring can fix an optical fiber with high accuracy in terms of the position of the center axis of the optical fiber and can easily be manufactured through a simple manufacturing process.

### BACKGROUND

1. Field

The present invention relates to an optical connector.

2. Description of the Related Art

Conventionally, optical connecters used for optical communications or the like include ferrules, such as a plastic ferrule formed of resin material through injection molding or a like molding process (see, for example, Japanese Patent Application Laid-Open (kokai) No. 2001-147343). Such a ferrule has a smaller-diameter through hole which is opened at a front end of the ferrule and in which an end portion of an optical fiber having its protection coating layer removed is accommodated, and a larger-diameter through hole which communicates with the smaller-diameter through hole and which accommodates a portion of the optical fiber adjacent to the end portion thereof and having the protection coating layer (hereinafter, an optical fiber having a protection coating layer will be referred to as “optical fiber core wire”). An end portion of an optical fiber core wire, from which an end portion of the optical fiber projects, is inserted into the larger-diameter through hole of the ferrule from an opening at the rear end thereof. Thus, the end portion of the optical fiber is accommodated within the smaller-diameter through hole, and a portion of the optical fiber core wire adjacent to the end portion of the optical fiber is accommodated within the larger-diameter through hole. The optical fiber is then fixed to the smaller-diameter through hole by use of adhesive.

However, in such an optical connector, since the diameter of the smaller-diameter through hole is set to be larger than the outer diameter of the optical fiber, the position of the optical fiber may shift in the radial direction. Thus, the size of the clearance between the inner circumferential surface of the smaller-diameter through hole and the outer circumferential surface of the optical fiber determines the extent of the positional shift of the center axis of the optical fiber. Further, when adhesive is used, a plurality of types of adhesive agents must be mixed to obtain an adhesive having bonding properties suitable for the materials of the ferrule and the optical fiber. This process is troublesome. Moreover, since such an adhesive must be used upon heating, a process of manufacturing an optical connector is complicated and time consuming. In order to overcome these drawbacks, there has been proposed a technique for fixing an optical fiber and optical fiber core wire to a ferrule by means of crimping. This technique eliminates the use of adhesive (see, for example, Japanese Patent Application Laid-Open (kokai) Nos. 2001-21757, 2002-341179, S62-125204, and S61-85815).

However, the above-described conventional optical connector in which adhesive is not used is complicated in structure, and a process of manufacturing such an optical connector is complicated and time consuming. Moreover, in order to improve the positional accuracy of the center axis of the optical fiber, center alignment must be performed carefully, and the number of manufacturing steps increases.

### SUMMARY OF THE INVENTION

An object of the present invention is to solve the above-mentioned problems of the conventional optical connector and to provide an optical connector which is configured such that a compression ring is fitted onto a front end portion of a ferrule so as to compressively deform the ferrule and thus reduce the diameter of a through hole formed in the ferrule, to thereby press and fixedly hold an optical fiber within the through hole from the outside; which can fix an optical fiber with high accuracy in terms of the position of the center axis of the optical fiber; and which can be easily manufactured through a simple manufacturing process.

In order to achieve the above object, the present invention provides an optical connector comprising a ferrule having a larger-diameter through hole for receiving an optical fiber core wire, and a smaller-diameter through hole for receiving an optical fiber projecting forward from the optical fiber core wire; and a compression ring fitted onto a smaller diameter portion of the ferrule, the smaller diameter portion extending over a predetermined range from a front end of the ferrule. The smaller-diameter through hole contracts as a result of the smaller diameter portion being press-fitted into the compression ring, and fixes the optical fiber received within the smaller-diameter through hole.

Preferably, the ferrule further includes a body portion located rearward of the smaller diameter portion and having a diameter greater than that of the smaller diameter portion and equal to or slightly larger than that of the compression ring.

Preferably, the predetermined range corresponds to at least a portion of the smaller-diameter through hole.

Preferably, the optical connector further comprises a lens sleeve having a lens portion on a front end surface thereof, wherein the smaller diameter portion, onto which the compression ring is fitted, and at least a portion of the body portion are accommodated within the lens sleeve.

Preferably, the body portion of the ferrule is press-fitted into the lens sleeve, whereby the lens sleeve is fixed to the ferrule.

In the optical connector according to the present invention, the compression ring is fitted onto the front end portion of the ferrule so as to compressively deform the ferrule and thus reduce the diameter of the through hole formed in the ferrule, to thereby press and fixedly hold an optical fiber within the through hole from the outside. Therefore, an optical fiber can be fixed with high accuracy in terms of the position of the center axis of the optical fiber, and the optical connector can be easily manufactured through a simple manufacturing process.

### BRIEF DESCRIPTION OF THE DRAWINGS

FIG. 1 is a perspective view of a ferrule according to a first embodiment of the present invention with a compression ring attached thereto;

FIG. 2 is a perspective view of the ferrule according to the first embodiment of the present invention;

FIG. 3 is a perspective view of the ferrule according to the first embodiment of the present invention with an optical-fiber-core-wire crimping member attached;

FIG. 4 is a side view showing a method for attaching the ferrule according to the first embodiment of the present invention to an optical fiber core wire and an optical fiber;

FIG. 5 is a sectional view showing the method for attaching the ferrule according to the first embodiment of the present invention to an optical fiber core wire and an optical fiber;

FIG. 6 is a perspective view of an optical connector assembly according to the first embodiment of the present invention;

FIG. 7 is a sectional view of the optical connector assembly according to the first embodiment of the present invention;

FIG. 8 is a perspective view showing a state in which a pair of optical connector assemblies according to the first embodiment of the present invention are connected with each other;

FIG. 9 is a sectional view showing a state in which the pair of optical connector assemblies according to the first embodiment of the present invention are connected with each other;

FIG. 10 is a perspective view showing a lens sleeve to be attached to a ferrule according to a second embodiment of the present invention;

FIG. 11 is a perspective view of the ferrule according to the second embodiment of the present invention with the lens sleeve attached thereto;

FIG. 12 is the first side view showing a method for attaching the ferrule according to the second embodiment of the present invention to an optical fiber core wire and an optical fiber;

FIG. 13 is the second side view showing a method for attaching the ferrule according to the second embodiment of the present invention to an optical fiber core wire and an optical fiber;

FIG. 14 is the first sectional view showing the method for attaching the ferrule according to the second embodiment of the present invention to an optical fiber core wire and an optical fiber;

FIG. 15 is the second sectional view showing the method for attaching the ferrule according to the second embodiment of the present invention to an optical fiber core wire and an optical fiber;

FIG. 16 is a perspective view of an optical connector assembly according to the second embodiment of the present invention;

FIG. 17 is a sectional view of the optical connector assembly according to the second embodiment of the present invention; and

FIG. 18 is a sectional view showing a state in which a pair of optical connector assemblies according to the second embodiment of the present invention are connected with each other.

### DETAILED DESCRIPTION

Embodiments of the present invention will next be described in detail with reference to the drawings.

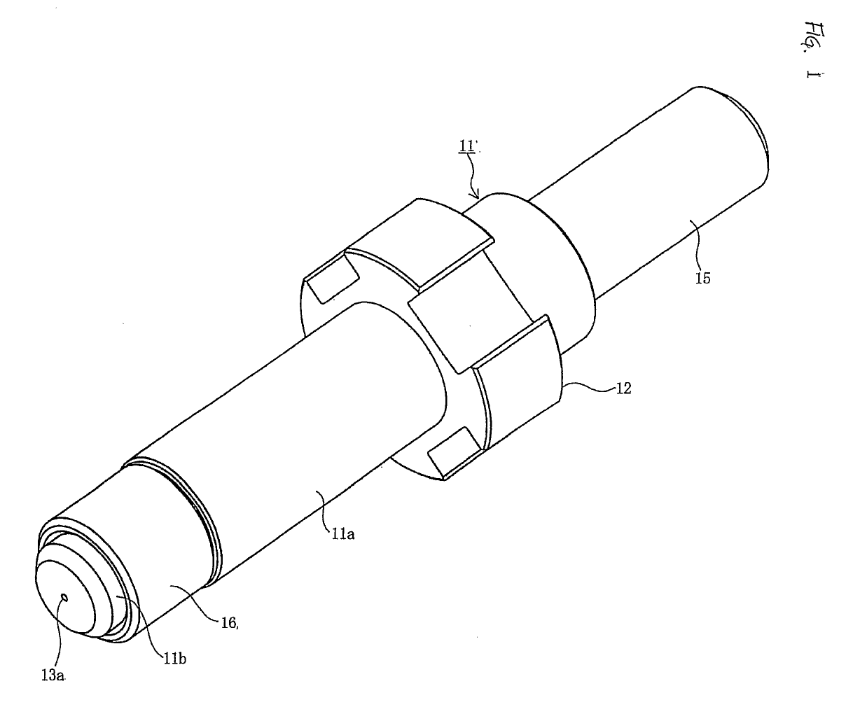

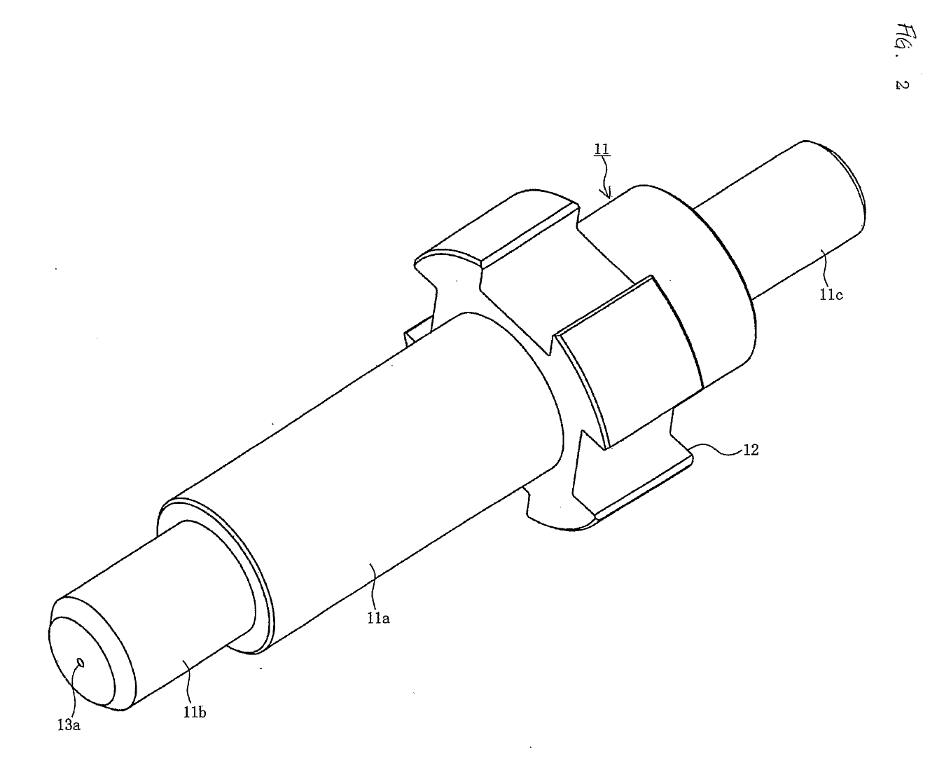

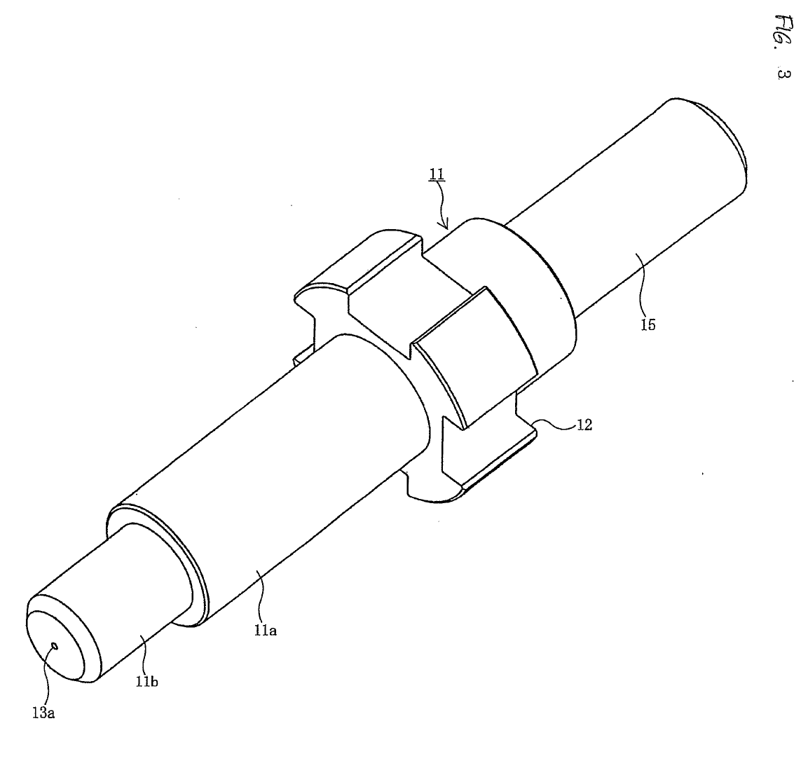

FIG. 1 is a perspective view of a ferrule according to a first embodiment of the present invention with a compression ring attached thereto; FIG. 2 is a perspective view of the ferrule according to the first embodiment of the present invention; and FIG. 3 is a perspective view of the ferrule according to the first embodiment of the present invention with an optical-fiber-core-wire crimping member attached thereto.

In these drawings, reference numeral 11 denotes a ferrule according to the present embodiment, and the ferrule 11 is fixed to a relaying terminal or a terminating end of an optical transmission line in an optical connector 10, which will be described later. In the present embodiment, a wire-like member composed of a bare fiber, serving as an optical transmission line, and a protection coating layer covering the bare fiber will be called an “optical fiber core wire”; and the bare fiber or a fiber corresponding thereto will be called an “optical fiber.” In the description of the present embodiment, terms for expressing direction, such as up, down, left, right, front, and rear, are for explaining the structure and action of portions of the optical connector 10. However, these terms represent respective directions for the case where the optical connector 10 is used in an orientation shown in the drawings, and must be construed to represent corresponding different directions when the orientation of the optical connector 10 is changed.

As show in FIG. 2, the ferrule 11 is a generally cylindrical member having a plurality of stepped portions. The ferrule 11 includes a body portion 11a, a front end portion (smaller-diameter portion) 11b projecting forward (toward a lower left direction in FIG. 2) from the body portion 11a, and a rear end portion 11c projecting rearward (toward an upper right direction in FIG. 2) from the body portion 11a. Notably, the ferrule 11 is dimensioned, for example, such that the outer diameter of the body portion 11a is about 1.25 mm. However, the dimensions of the ferrule 11 may be set freely. The front end portion 11b and the rear end portion 11c, which are smaller in diameter than the body portion 11a, are formed integrally and coaxially with the body portion 11a. The peripheral edge of the front end surface of the front end portion 11b is chamfered so as to facilitate insertion of the front end portion 11b into a slit sleeve or the like, for example, when the optical connector is connected to a counterpart connector. The ferrule 11 is formed of an engineering plastic such as PBT (polybutyrene terephthalate), PC (polycarbonate), LCP (liquid crystal polymer), PPS (polyphenyl sulfide), polyamide, or PEEK (polyetherether ketone), and is integrally molded by means of injection molding or a like molding process.

Reference numeral 12 denotes a flange which is formed from an engineering plastic, integrally with the ferrule 11. Notably, the flange 12 may be formed from metal, and may be molded separately from the ferrule 11. In this case, the body portion 11a of the ferrule 11 is press-fitted into a through hole formed at the center of the flange 12.

Further, a through hole 13 to be described later is formed in the ferrule 11. The through hole 13 is formed to share the center axis with the ferrule 11, and is composed of a smaller-diameter through hole 13a opened to the front end surface of the front end portion 11b, a larger-diameter through hole 13b (to be described later) opened to the rear end surface of the rear end portion 11c, and a taper portion 13c (to be described later) connecting the smaller-diameter through hole 13a and the larger-diameter through hole 13b. An optical fiber 22 to be described later is accommodated within the smaller-diameter through hole 13a, and an optical fiber core wire 21 to be described later is accommodated within the larger-diameter through hole 13b. Notably, the diameter of the smaller-diameter through hole 13a is larger than the outer diameter of the optical fiber 22 by a small amount (e.g., about 0.05 to 2.0 μm), and the diameter of the larger-diameter through hole 13b is larger than the outer diameter of the optical fiber core wire 21 by a small amount (e.g., about 10 to 500 μm).

As shown in FIGS. 1 and 3, a core wire fixing member 15 for fixing the optical fiber core wire 21 is attached to the rear end portion tic of the ferrule 11. The core wire fixing member 15 is a generally cylindrical member, and the rear end portion 11c is inserted into the core wire fixing member 15 for fixation. The core wire fixing member 15 is formed to share the center axis with the ferrule 11, and has a core wire through hole 15a to be described later, which has a diameter approximately equal to that of the larger-diameter through hole 13b. The core wire through hole 15a is located rearward of the larger-diameter through hole 13b and receives the optical fiber core wire 21.

Further, as shown in FIG. 1, a compression ring 16 for fixing the optical fiber 22 is attached to the front end portion 11b of the ferrule 11. The compression ring 16 has an inner diameter smaller than the outer diameter of the front end portion 11b by a small amount (e.g., 50 μm). When the front end portion 11b is press-fitted into the compression ring 16, the front end portion 11b is compressively deformed, so that the diameter of the smaller-diameter through hole 13a is reduced, and thus, the optical fiber 22 accommodated within the smaller-diameter through hole 13a is fixed. Notably, the outer diameter of the compression ring 16 is approximately equal to the outer diameter of the body portion 11a; e.g., about 1.25 mm. This enables smooth insertion of the body portion 11a of the ferrule 11 when it is inserted into another member such as a connector housing 31, which will be described later.

The compression ring 16 is formed of a material having a rigidity higher than that of the ferrule 11. For example, in the case where the material of the ferrule 11 is an engineering plastic such as LCP, PPS, polyamide, or PEEK, the compression ring 16 is preferably formed of a metal such as stainless steel (SUS) or brass. Notably, the compression ring 16 may be formed of a resin. For example, in the case where the material of the ferrule 11 is a relatively soft engineering plastic such as PBT or PC, the compression ring 16 may be formed of a relatively hard engineering plastic such as PPS, polyamide, or PEEK. That is, the compression ring 16 may be formed of a material of any type, so long as the selected material has a rigidity higher than that of the ferrule 11. For example, when the material of the ferrule 11 has a hardness of about 70 as measured in Rockwell hardness (M scale) in accordance with JIS K7202-2: 2001, the material of the compression ring 16 preferably has a hardness of about 100.

Next, a method of attaching the ferrule 11 to the optical fiber core wire 21 and the optical fiber 22 will be described.

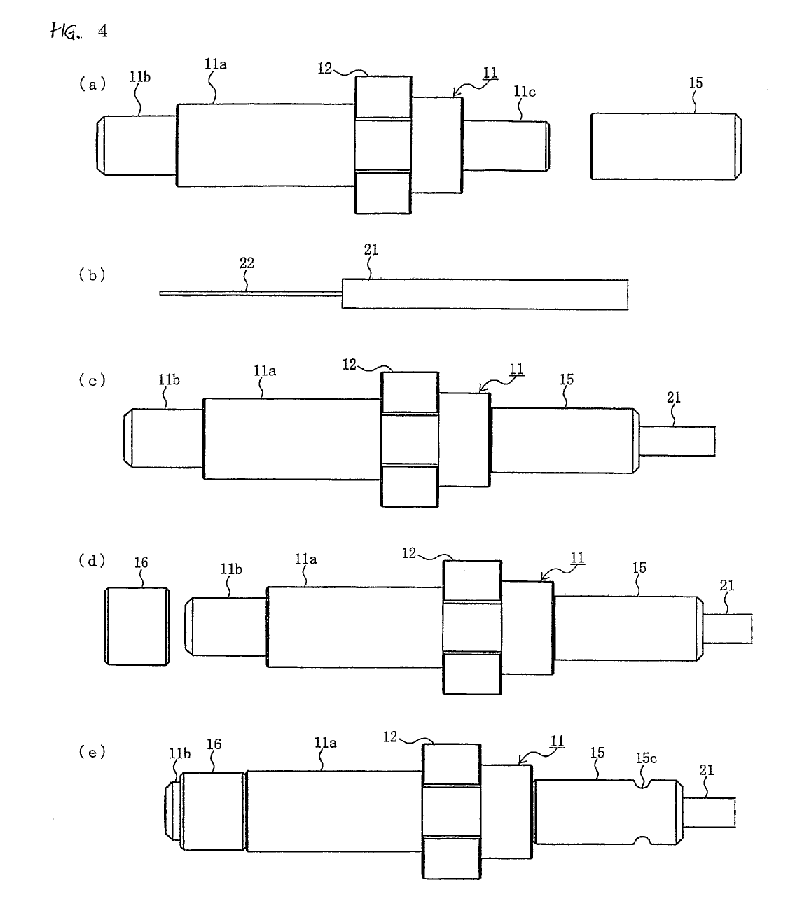

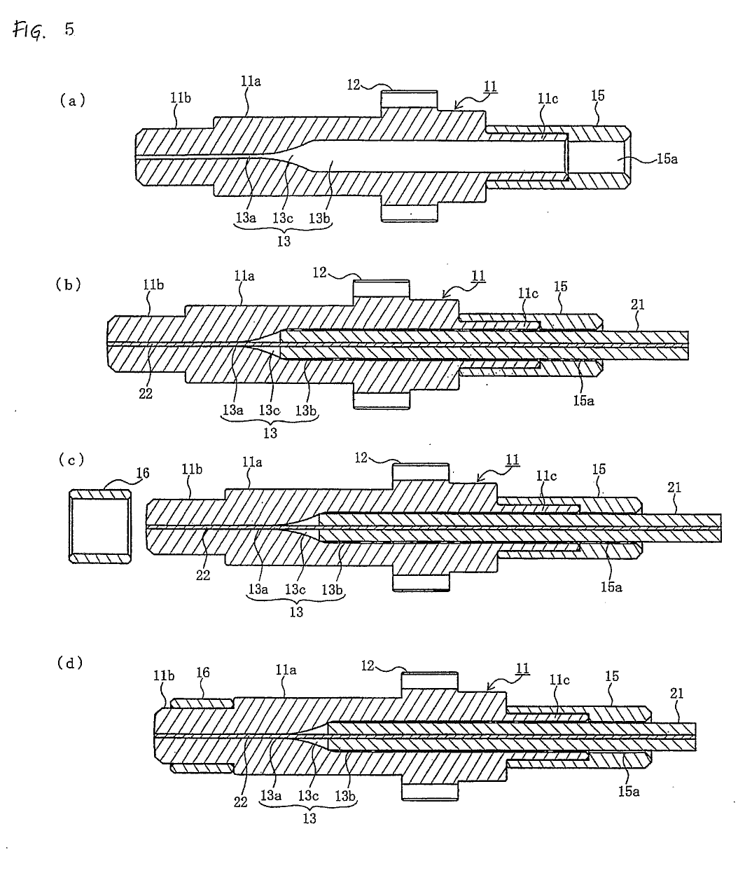

FIG. 4 is a side view showing a method for attaching the ferrule according to the first embodiment of the present invention to the optical fiber core wire and the optical fiber; and FIG. 5 is a sectional view showing the method for attaching the ferrule according to the first embodiment of the present invention to the optical fiber core wire and the optical fiber.

First, the core wire fixing member 15, which is positioned reward of the ferrule 11 as shown in FIG. 4A, is fitted and fixed to the rear end portion 11c, as shown in FIG. 5A. Thus, the through hole 13 formed in the ferrule 11 and the core wire through hole 15a of the core wire fixing member 15 are disposed on a common axis, whereby they share the center axis.

Subsequently, as shown in FIG. 4B, the protection coating layer is removed from the leading end portion of the optical fiber core wire 21 over a predetermined length so as to expose a leading end portion of the optical fiber 22, the end portion having a predetermined length. Thus, the leading end portion of the optical fiber 22 projects forward from the optical fiber core wire 21. Notably, the optical fiber 22 may be a single mode fiber or a multimode fiber, and may be a quartz fiber formed of quartz or a plastic fiber formed of polymer such as acrylic resin or fluorocarbon resin. The protection coating layer of the optical fiber core wire 21 is formed of, for example, polyethylene resin, polyvinyl chloride resin, polyamide resin, urethane resin, or epoxy resin. However, the protection coating layer may be formed of a material of any type so long as the selected material can protect the optical fiber 22 physically and chemically. Notably, although the outer diameter of the optical fiber 22 is about 125 μm, it can be determined freely. Although the outer diameter of the protection coating layer of the optical fiber core wire 21 is about 250 μm, it can be determined freely.

Subsequently, the optical fiber core wire 21, from which the optical fiber 22 projects, is inserted into the through hole 13 and the core wire through hole 15a from the rear side of the ferrule 11. Thus, as shown in FIGS. 4C and 5B, the leading end portion of the optical fiber 22 is accommodated within the smaller-diameter through hole 13a, and the leading end portion of the optical fiber core wire 21 is accommodated within the larger-diameter through hole 13b and the core wire through hole 15a. In this case, since the smaller-diameter through hole 13a communicates to the larger-diameter through hole 13b via the taper portion 13c, whose diameter decreases gradually, the optical fiber 22 is smoothly inserted into the smaller-diameter through hole 13a. When the leading end of the protection coating layer of the optical fiber core wire 21 abuts the inner wall of the taper portion 13c, the insertion of the optical fiber core wire 21 is stopped. The above-described predetermined length, by which the optical fiber 22 projects forward from the optical fiber core wire 21, is determined such that when the insertion of the optical fiber core wire 21 is stopped, the leading end surface of the optical fiber 22 form a common surface together with the front end surface of the front end portion 11b; i.e., becomes flush with the front end surface of the front end portion 11b. Therefore, by stopping the insertion operation when the leading end of the protection coating layer of the optical fiber core wire 21 abuts the inner wall of the taper portion 13c, the leading end surface of the optical fiber 22 can be positioned at a proper position. Alternatively, a jig for abutment may be disposed on the front end surface of the front end portion 11b of the ferrule 11, and the optical fiber core wire 21 may be inserted until the leading end surface of the optical fiber 22 abuts the jig.

Subsequently, as shown in FIGS. 4D and 5C, the compression ring 16 is fitted onto the front end portion 11b of the ferrule 11 from the front side thereof. Since the inner diameter of the compression ring 16 is slightly smaller than the outer diameter of the front end portion 11b, the front end portion 11b is pressed-fitted into the compression ring 16, and is compressively deformed. Thus, as shown in FIG. 5D, the compression ring 16 is moved until its rear end (right-hand end in FIG. 5D) abuts the stepped portion or shoulder portion between the body portion 11a and the front end portion 11b, and is attached to the front end portion 11b. Notably, the axial length of the compression ring 16 is slightly smaller than that of the front end portion 11b. Therefore, in a rang corresponding to the generally entire length of the front end portion 11b, the smaller-diameter through hole 13a is contracted, and the leading end portion of the optical fiber 22 accommodated within the smaller-diameter through hole 13a is fixed. Notably, the axial length of the front end portion 11b may be determined freely. For example, the front end portion 11b may have an axial length such that the front end portion 11b overlaps a front end portion of the larger-diameter through hole 13b. In this case, since the axial length of the compression ring 16 is determined to be equal to that of the front end portion 11b, the entire leading end portion of the optical fiber 22 projecting forward from the optical fiber core wire 21 can be fixed. Notably, the protection coating layer of the optical fiber core wire 21 is preferably not compressed by the compression ring 16.

Subsequently, as shown in FIG. 4E, a portion of the core wire fixing member 15 is plastically deformed to a degree such that a concave portion 15c is formed, whereby the optical fiber core wire 21 passing through the core wire through hole 15a is crimp-fixed. Thus, the protection coating layer of the optical fiber core wire 21 is pressed toward the center axis by means of the inner wall surface of the core wire through hole 15a having been deformed at a position corresponding to the concave portion 15c, whereby the protection coating layer is fixed to the core wire fixing member 15. Notably, the depth and axial length of the concave portion 15c must be determined such that a transmission loss of light in the optical fiber 22 at a location corresponding to the concave portions becomes substantially ignorable. That is, the magnitude and range of application of a force applied for crimp fixing are set such that the transmission loss of light in the optical fiber 22 becomes substantially ignorable. Notably, the protection coating layer of the optical fiber core wire 21 may be fixed to the core wire fixing member 15 by any fixing method other than crimp fixing; e.g., bonding by use of adhesive.

Next, an optical connector assembly which includes the ferrule 11 will be described.

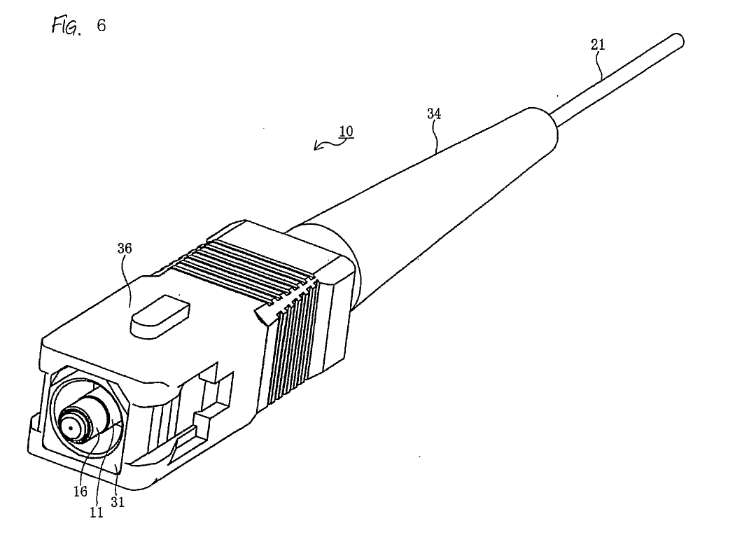

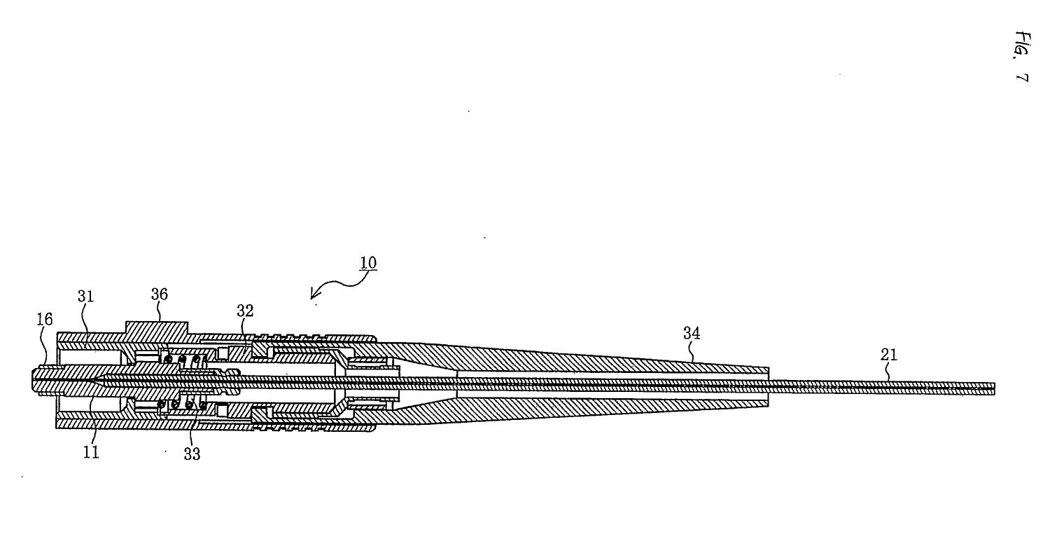

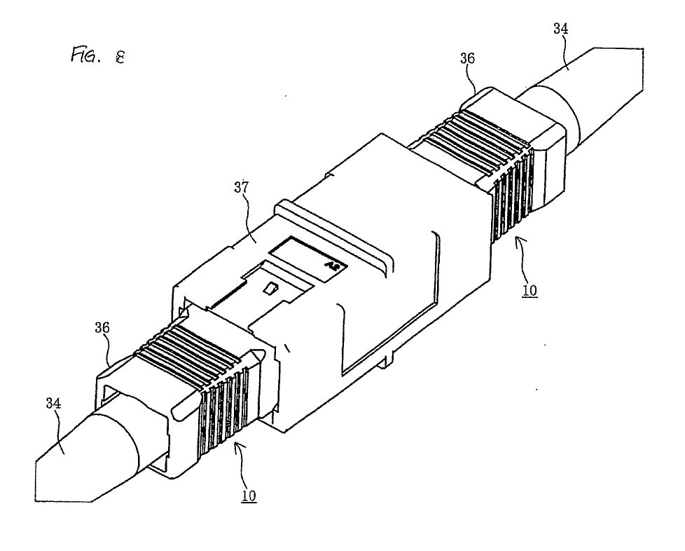

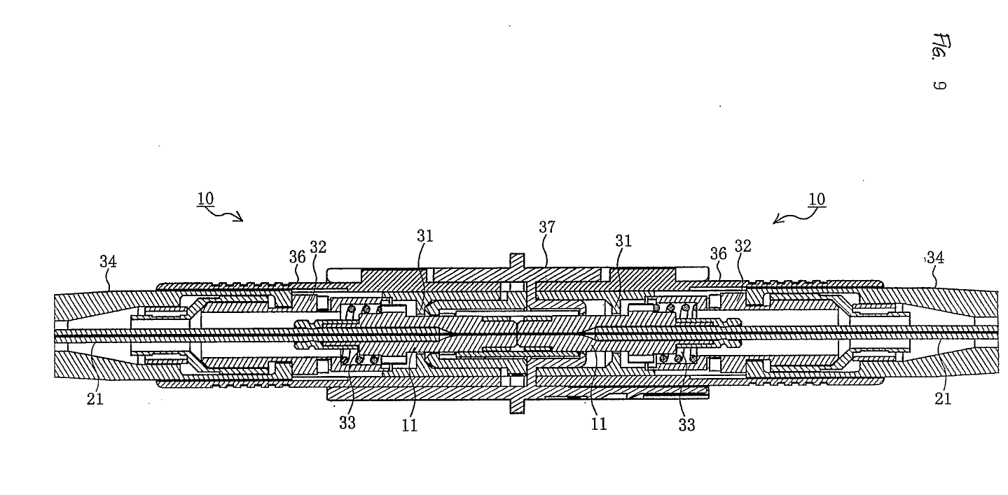

FIG. 6 is a perspective view of an optical connector assembly according to the first embodiment of the present invention; FIG. 7 is a sectional view of the optical connector assembly according to the first embodiment of the present invention; FIG. 8 is a perspective view showing a state in which a pair of optical connector assemblies according to the first embodiment of the present invention are connected with each other; and FIG. 9 is a sectional view showing a state in which the pair of optical connector assemblies according to the first embodiment of the present invention are connected with each other.

The ferrule 11, to which the optical fiber core wire 21 and the optical fiber 22 have been attached in the above-described manner, is assembled within an optical connector 10, which serves as an optical connector assembly, as shown in FIG. 7. Specifically, after a portion of the ferrule 11 on the front side of the flange 12 is inserted into the interior space of a connector housing 31, by means of a spring 33 serving as an elastic member, the flange 12 is pressed from the rear side against an internal projection of the connector housing 31. That is, the flange 12 is elastically held from the front and rear sides thereof by means of the internal projection of the connector housing 31 and the spring 33. Notably, the spring 33 is supported from the rear side thereof by means of a holding member 32 attached to the rear end of the connector housing 31.

Further, a strain release boot 34 extending rearward is attached to the holding member 32. The strain release boot 34 is a hollow member surrounding the circumference of the optical fiber core wire 21 and protecting a portion of the optical fiber core wire 21 in the vicinity of the optical connector 10 from bending stress and the like. Moreover, an outer casing 36 is attached to the outer circumference of the connector housing 31, the outer circumference of the holding member 32, and a portion of the outer circumference of the strain release boot 34. As shown in FIG. 6, an uneven portion (annular projections and grooves), which is used for, for example, positioning for connection with a counterpart connector is formed on the outer circumferential surface of the outer casing 36.

As shown in FIGS. 8 and 9, the optical connector 10 is connected to another optical connector 10 via a connection adaptor 37. In this case, the front end surfaces of the front end portions l lb of the ferrules 11 of the two optical connectors 10 come into contact with each other, and the leading end surfaces of the optical fibers 22 of the two optical connectors 10 come into contact with each other, such that the center axes of the two optical fibers 22 coincide with each other. Thus, light transmitted through one optical fiber 22 can be transmitted to the other optical fiber 22. Notably, the counterpart connector to be connected to the optical connector 10 is not required to be of the same type as that of the optical connector 10. For example, the counterpart connector may be a header connector which includes a light receiving element and a light emitting element and which is fixed to a circuit board.

As described above, in the present embodiment, the diameter of the smaller-diameter through hole 13a formed in the ferrule 11 is reduced by fitting the compression ring 16 onto the front end portion 11b of the ferrule 11, whereby the leading end portion of the optical fiber 22 accommodated within the smaller-diameter through hole 13a is pressed and held for fixation. Therefore, the position of the center axis of the optical fiber 22 does not shift when the optical fiber 22 is fixed to the ferrule 11, so that the optical fiber 22 can be fixed with high accuracy in terms of the position of the center axis, and thus a reliable optical connector 10 can be obtained. Moreover, since the compression ring 16, which is simple in structure, is only required to be fitted onto the front end portion 11b of the ferrule 11, the attachment of the compression ring 16 can be performed easily, and the production cost of the optical connector 10 can be reduced.

Further, since the ferrule 11 is only required to have the front end portion 11b whose outer diameter is smaller than that of the body portion 11a, the structure of the ferrule 11 can be simplified, and the ferrule 11 can be obtained though a simple manufacturing process. When the length of the range of the optical fiber 22 to be fixed by means of the compression ring 16 is changed, it is only required to change the axial lengths of the compression ring 16 and the front end portion 11b, which can be performed easily.

Moreover, since adhesive is not required to fix the optical fiber 22, a step for preparing an adhesive suitable for the material of the optical fiber 22 and a step for heating the adhesive can be eliminated, so that the optical connector 10 can be manufactured through a simple manufacturing process.

Next, a second embodiment of the present invention will be described. Components having the same structures as those of the first embodiment will be denoted by the same reference numerals, and descriptions therefor are omitted. Also, descriptions for an action and effects which are the same as those attained in the first embodiment will also be omitted.

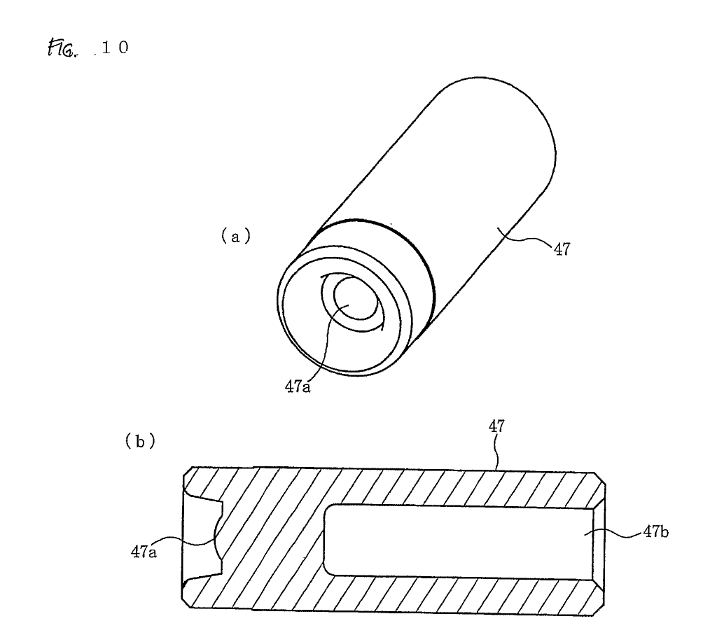

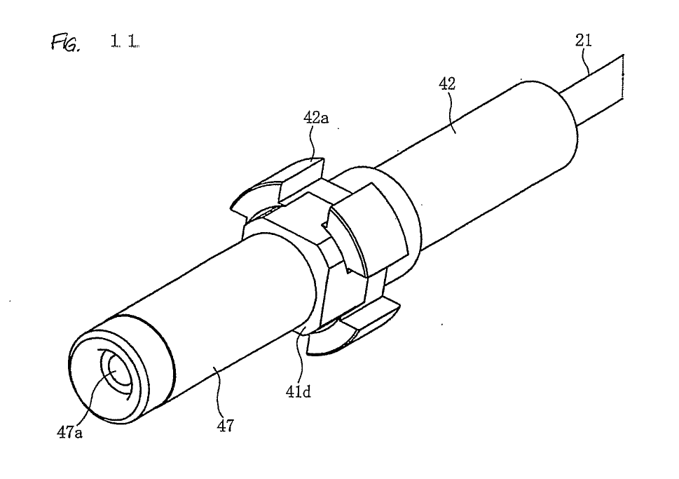

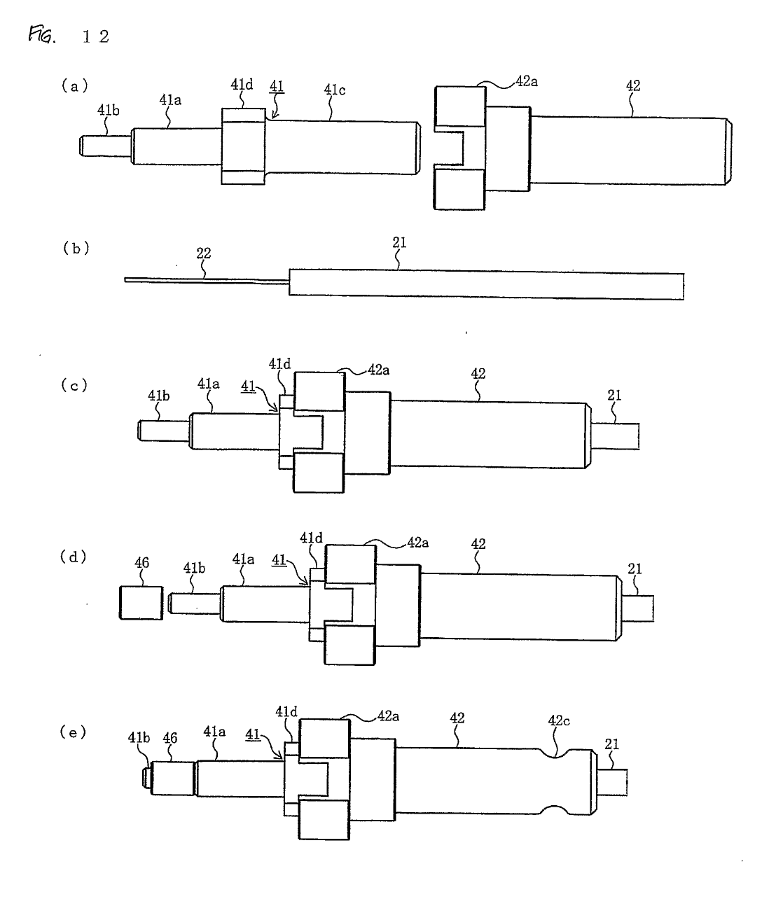

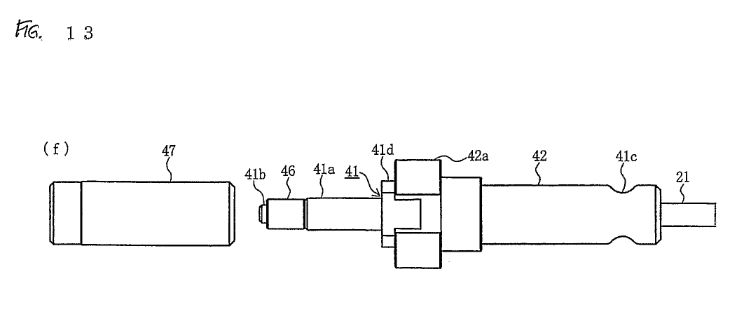

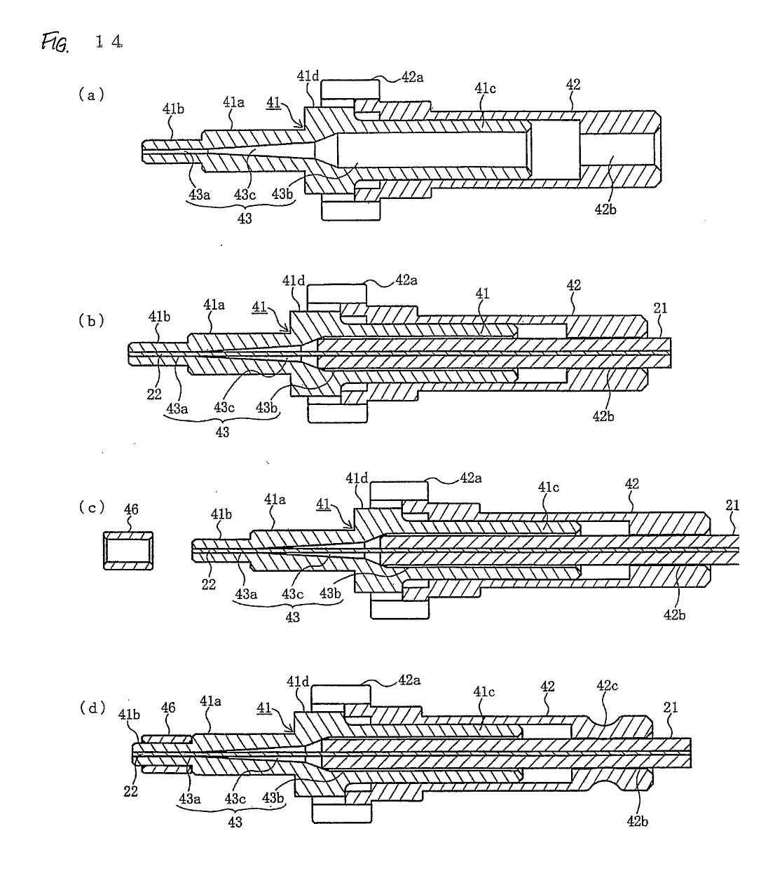

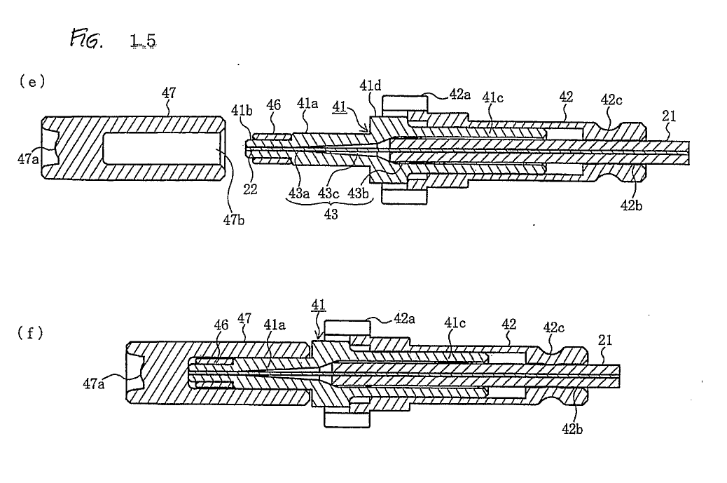

FIG. 10 is a perspective view showing a lens sleeve to be attached to a ferrule according to the second embodiment of the present invention; FIG. 11 is a perspective view of the ferrule according to the second embodiment of the present invention with the lens sleeve attached thereto; FIG. 12 is the first side views showing a method for attaching the ferrule according to the second embodiment of the present invention to an optical fiber core wire and an optical fiber; FIG. 13 is the second side view showing a method for attaching the ferrule according to the second embodiment of the present invention to an optical fiber core wire and an optical fiber; FIG. 14 is the first sectional view showing the method for attaching the ferrule according to the second embodiment of the present invention to an optical fiber core wire and an optical fiber; and FIG. 15 is the second sectional view showing the method for attaching the ferrule according to the second embodiment of the present invention to an optical fiber core wire and an optical fiber In FIG. 10, reference numeral 47 denotes a lens sleeve in which a lens 47a such as convex lens, concave lens, or collimation lens is integrally formed on the front end surface thereof. The lens sleeve 47 is formed of optical glass, transparent resin, or a like material, and a front end of a ferrule 41 is inserted into an insertion hole 47b. Further, as shown in FIGS. 12 to 15, the ferrule 41 of the present embodiment is a generally cylindrical member having a plurality of stepped portions. The ferrule 41 includes a body portion 41a, a front end portion (smaller-diameter portion) 41b projecting forward (leftward in FIGS. 12 to 15) from the body portion 41a, and a rear end portion 41c projecting rearward (rightward in FIGS. 12 to 15) from the body portion 41a. Notably, the dimensions and material of the ferrule 41 are identical with those of the ferrule 11 of the first embodiment. The front end portion 41b is smaller in diameter than the body portion 41a, but the rear end portion 41c is larger in diameter than the body portion 41a. The front end portion 41b and the rear end portion 41c are formed integrally with the body portion 41a such that they share the center axis with the body portion 41a. Reference numeral 41d denotes a flange formed integrally with the body portion 41a.

Further, a through hole 43 is formed in the ferrule 41. The through hole 43 is formed to share the center axis with the ferrule 41, and is composed of a smaller-diameter through hole 43a opened to the front end surface of the front end portion 41b, a larger-diameter through hole 43b opened to the rear end surface of the rear end portion 41c, and a taper portion 43c connecting the smaller-diameter through hole 43a and the larger-diameter through hole 43b. An optical fiber 22 is accommodated within the smaller-diameter through hole 43a, and an optical fiber core wire 21 is accommodated within the larger-diameter through hole 43b. Notably, the dimensions of the smaller-diameter through hole 43a and the larger-diameter through hole 43b are the same as those of the smaller-diameter through hole 13a and the larger-diameter through hole 13b in the first embodiment.

As shown in FIG. 11, a core wire fixing member 42 for fixing the optical fiber core wire 21 is attached to the rear end portion 41c of the ferrule 41. The core wire fixing member 42 is a generally cylindrical member, and, as shown in FIG. 14, the rear end portion 41c is inserted into the core wire fixing member 42 for fixation. The core wire fixing member 42 is formed to share the center axis with the ferrule 41, and has a core wire through hole 42b, which has a diameter approximately equal to that of the larger-diameter through hole 43b. The core wire through hole 42b is located rearward of the larger-diameter through hole 43b and receives the optical fiber core wire 21. Notably, a press-fitting flange 42a having an outer diameter greater than that of the flange 41d of the ferrule 41 is formed integrally with the core wire fixing member 42.

Further, as shown in FIGS. 12 to 15, a compression ring 46 for fixing the optical fiber 22 is attached to the front end portion 41b of the ferrule 41. The dimension, material, rigidity, etc. of the compression ring 46 are the same as those of the compression ring 16 in the first embodiment.

The insertion hole 47b of the lens sleeve 47 has a length such that the entirety of a portion of the ferrule 41 located on the front side of the flange 41d; i.e., the body portion 41a and the front end portion 41b, can be inserted into the insertion hole 47b. The diameter of the insertion hole 47b is approximately equal to the outer diameter of the body portion 41a; however, it is desired to be slightly smaller than the outer diameter of the body portion 41a. Thus, there is established a state in which the body portion 41a is press-fitted into the insertion hole 47b, and the insertion hole 47b shores the center axis with the body portion 41a. As a result, the center axis of the lens 47a coincides with the center axis of the leading end portion of the optical fiber 22 fixedly held within the smaller-diameter through hole 43a, and no positional shift is produced between the center axis of the lens 47a and the center axis of the optical fiber 22.

Next, a method of attaching the ferrule 41 to the optical fiber core wire 21 and the optical fiber 22 and then attaching the lens sleeve 47 to the ferrule 41 will be described.

First, the core wire fixing member 42, which is positioned reward of the ferrule 41 as shown in FIG. 12A, is fitted and fixed to the rear end portion 41c, as shown in FIG. 14A. In this case, the press-fitting flange 42a abuts the flange 41d of the ferrule 41 from the rear side. Thus, the through hole 43 formed in the ferrule 41 and the core wire through hole 42b of the core wire fixing member 42 are disposed on a common axis, whereby they share the center axis.

Subsequently, as shown in FIG. 12B, the protection coating layer is removed from the leading end portion of the optical fiber core wire 21 over a predetermined length so as to expose a leading end portion of the optical fiber 22, the end portion having a predetermined length. Thus, the leading end portion of the optical fiber 22 projects forward from the optical fiber core wire 21. Notably, since the optical fiber core wire 21 and the optical fiber 22 are identical with those used in the first embodiment, their descriptions are omitted.

Subsequently, the optical fiber core wire 21, from which the optical fiber 22 projects, is inserted into the through hole 43 and the core wire through hole 42b from the rear side of the ferrule 41. Thus, as shown in FIGS. 12C and 14B, the leading end portion of the optical fiber 22 is accommodated within the smaller-diameter through hole 43a, and the leading end portion of the optical fiber core wire 21 is accommodated within the larger-diameter through hole 43b and the core wire through hole 42b. In this case, since the smaller-diameter through hole 43a communicates to the larger-diameter through hole 43b via the taper portion 43c, whose diameter decreases gradually, the optical fiber 22 is smoothly inserted into the smaller-diameter through hole 43a. When the leading end of the protection coating layer of the optical fiber core wire 21 abuts the inner wall of the taper portion 43c, the insertion of the optical fiber core wire 21 is stopped. Notably, since the stoppage of insertion of the optical fiber core wire 21 and the positional relation between the leading end surface of the optical fiber 22 and the front end surface of the front end portion 41b are identical with those in the first embodiment, their descriptions are omitted.

Subsequently, as shown in FIGS. 12D and 14C, the compression ring 46 is fitted onto the front end portion 41b of the ferrule 41 from the front side thereof. Since the inner diameter of the compression ring 46 is slightly smaller than the outer diameter of the front end portion 41b, the front end portion 41b is pressed-fitted into the compression ring 46, and is compressively deformed. Thus, as shown in FIG. 14D, the compression ring 46 is moved until its rear end (right-hand end in FIG. 14D) abuts the stepped portion or shoulder portion between the body portion 41a and the front end portion 41b, and is attached to the front end portion 41b. With this, in a rang corresponding to the generally entire length of the front end portion 41b, the smaller-diameter through hole 43a is contracted, and the leading end portion of the optical fiber 22 accommodated within the smaller-diameter through hole 43a is fixed. Notably, since the axial length of the compression ring 46 is identical with that in the first embodiment, its description is omitted.

Subsequently, as shown in FIGS. 12E and 14D, a portion of the core wire fixing member 42 is plastically deformed to a degree such that a concave portion 42c is formed, whereby the optical fiber core wire 21 passing through the core wire through hole 42b is crimp-fixed. Thus, the protection coating layer of the optical fiber core wire 21 is pressed toward the center axis by means of the inner wall surface of the core wire through hole 42b having been deformed at a position corresponding to the concave portion 42c, whereby the protection coating layer is fixed to the core wire fixing member 42. Notably, the depth and axial length of the concave portion 42c are identical with those in the first embodiment, their descriptions are omitted. Notably, the protection coating layer of the optical fiber core wire 21 may be fixed to the core wire fixing member 42 by any fixing method other than crimp fixing; e.g., bonding by use of adhesive.

Next, as shown in FIGS. 12F and 15E, the lens sleeve 47 is attached to the ferrule 41 from the front side thereof. As shown in FIG. 15F, the body portion 41a and the front end portion 41b with the compression ring 46 fitted thereto are inserted into and accommodated within the insertion hole 47b. As described above, when the diameter of the insertion hole 47b is slightly smaller than the outer diameter of the body portion 41a, there is established a state in which the body portion 41a is press-fitted into the insertion hole 47b, so that no positional shift is produced between the center axis of the lens 47a and that of the optical fiber 22. The outer diameter of the lens sleeve 47 is properly adjusted to match a counterpart connector to which an optical connector 40 to be described later is connected. For example, in the case the lens sleeve 47 is inserted into a slit sleeve of a counterpart connector, the outer diameter of the lens sleeve 47 is preferably determined to be slightly larger than the inner diameter of the slit sleeve. Specifically, in the case where the slit sleeve is a slit sleeve for SC connecters, the outer diameter of the lens sleeve 47 is preferably set to about 2.5 mm; and in the case the slit sleeve is a slit sleeve for MU connecters, the outer diameter of the lens sleeve 47 is preferably set to about 1.25 min. Moreover, as described above, the lens 47a is a convex lens, a concave lens, a collimation lens, or the like, and has a function of converging or scattering light. However, a lens type is freely selected in accordance with an intended application.

Next, an optical connector assembly which includes the ferrule 41 will be described.

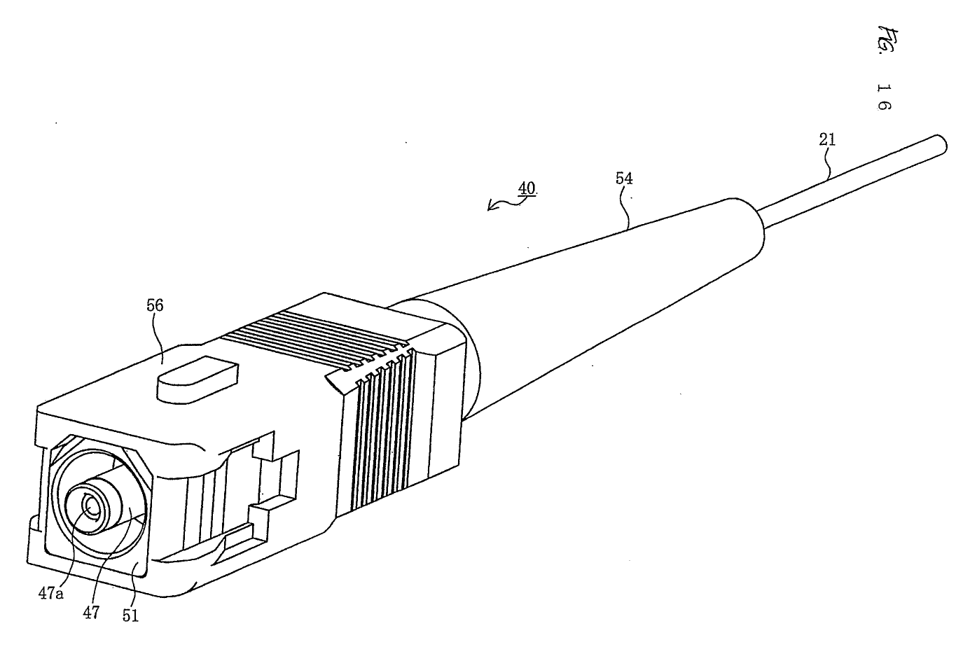

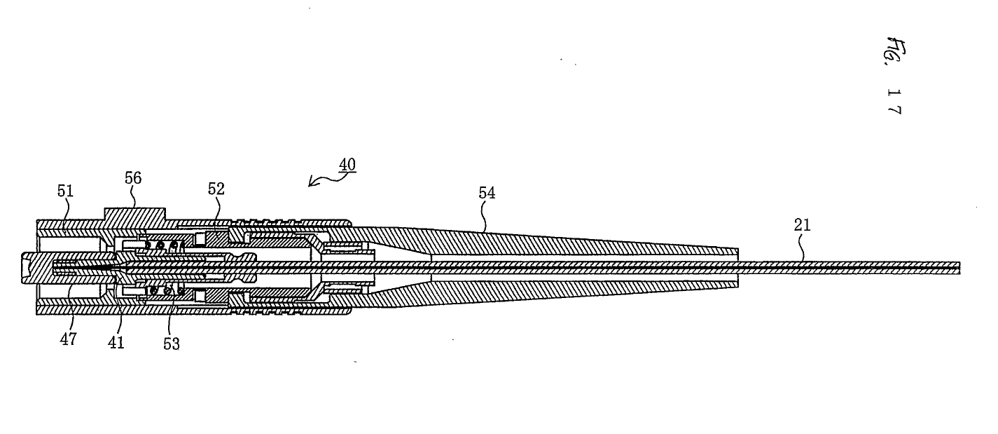

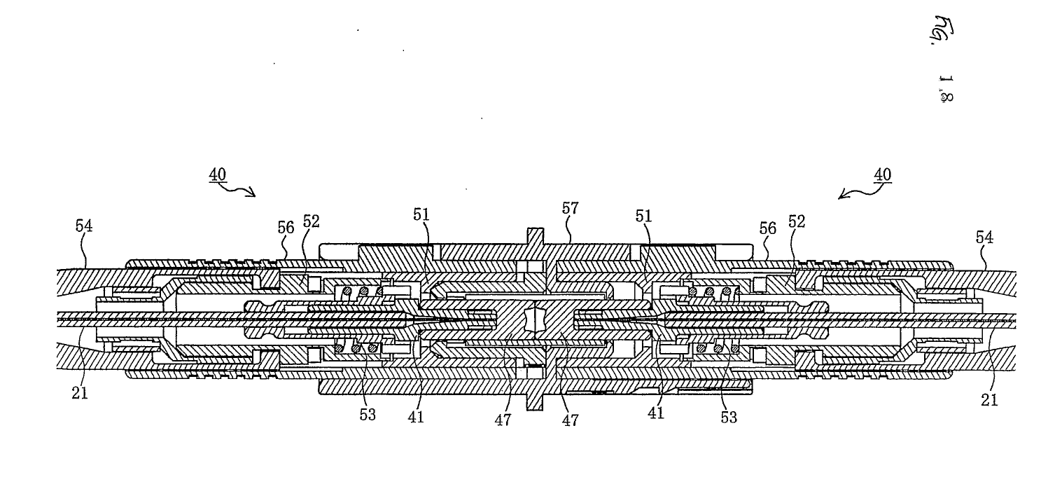

FIG. 16 is a perspective view of an optical connector assembly according to the second embodiment of the present invention; FIG. 17 is a sectional view of the optical connector assembly according to the second embodiment of the present invention; and FIG. 18 is a sectional view showing a state in which a pair of optical connector assemblies according to the second embodiment of the present invention are connected with each other.

The ferrule 41, which has been attached to the optical fiber core wire 21 and the optical fiber 22 and to which the lens sleeve 47 has been attached in the above-described manner, is assembled within an optical connector 40, which serves as an optical connector assembly, as shown in FIG. 17. Specifically, after a portion of the ferrule 41 on the front side of the press-fitting flange 42a is inserted into the interior space of a connector housing 51, by means of a spring 53 serving as an elastic member, the press-fitting flange 42a is pressed from the rear side against an internal projection of the connector housing 51. That is, the press-fitting flange 42a is elastically held from the front and rear sides thereof by means of the internal projection of the connector housing 51 and the spring 53. Notably, the spring 53 is supported from the rear side thereof by means of a holding member 52 attached to the rear end of the connector housing 51.

Further, a strain release boot 54 extending rearward is attached to the holding member 52. Since the strain release boot 54 is the same as that in the first embodiment, its description are omitted. Moreover, an outer casing 56 is attached to the outer circumference of the connector housing 51, the outer circumference of the holding member 52, and a portion of the outer circumference of the strain release boot 54. As shown in FIG. 16, an uneven portion (annular projections and grooves), which is used for, for example, positioning for connection with a counterpart connector is formed on the outer circumferential surface of the outer casing 56.

As shown in FIG. 18, the optical connector 40 is connected to another optical connector 40 via a connection adaptor 57. In this case, the front end surfaces of the lens sleeves 47 of the two optical connectors 40 come into contact with each other, the center axes of the two lens sleeves 47 coincide with each other, and the center axes of the two optical fibers 22 coincide with each other. Thus, light transmitted through one optical fiber 22 can be transmitted to the other optical fiber 22. Notably, the counterpart connector to be connected to the optical connector 40 is not required to be of the same type as that of the optical connector 40. For example, the counterpart connector may be a header connector which includes a light receiving element and a light emitting element and which is fixed to a circuit board.

As described above, in the present embodiment, through a simple operation of attaching the lens sleeve 47 with the integrally formed lens 47a in such a manner that the lens sleeve 47 covers the outer periphery of the front end portion of the ferrule 41, the lens 47a having a function of converging or scattering light transmitted through the optical fiber 22 can be easily attached. Further, the optical fiber 22 accommodated within the smaller-diameter through hole 43a is pressed and held for fixation by fitting the compression ring 46, which has high rigidity, onto the front end portion 41b of the ferrule 41. Therefore, even when lens sleeve 47 is attached to cover the compression ring 46, the position of the center axis of the optical fiber 22 does not shift. Therefore, no transmission loss of light is produced stemming from the positional shift of the center axis of the optical fiber 22, and the step of adjusting the position of the center axis of the optical fiber 22 can be eliminated.

Since the actions and effects in other aspects are the same as those in the first embodiment, their descriptions are omitted.

The present invention is not limited to the above-described embodiment. Numerous modifications and variations of the present invention are possible in light of the spirit of the present invention, and they are not excluded from the scope of the present invention.

What is claimed is:

1. An optical connector comprising:
a ferrule having a larger-diameter through hole for receiving an optical fiber core wire, and a smaller-diameter through hole for receiving an optical fiber projecting forward from the optical fiber core wire; and
a compression ring fitted onto a smaller diameter portion of the ferrule, the smaller diameter portion extending over a predetermined range from a front end of the ferrule, wherein
the smaller-diameter through hole contracts as a result of the smaller diameter portion being press-fitted into the compression ring and fixes the optical fiber received within the smaller-diameter through hole.

2. An optical connector according to claim 1, wherein the ferrule further includes a body portion located rearward of the smaller diameter portion and having a diameter greater than that of the smaller diameter portion and equal to or slightly larger than that of the compression ring.

3. An optical connector according to claim 1, wherein the predetermined range corresponds to at least a portion of the smaller-diameter through hole.

4. An optical connector according to claim 2, wherein the predetermined range corresponds to at least a portion of the smaller-diameter through hole.

5. An optical connector according to claim 2, further comprising:
a lens sleeve having a lens portion on a front end surface thereof, wherein
the smaller diameter portion, onto which the compression ring is fitted, and at least a portion of the body portion are accommodated within the lens sleeve.

6. An optical connector according to claim 3, further comprising:
a lens sleeve having a lens portion on a front end surface thereof, wherein
the smaller diameter portion, onto which the compression ring is fitted, and at least a portion of the body portion are accommodated within the lens sleeve.

7. An optical connector according to claim 4, further comprising:
a lens sleeve having a lens portion on a front end surface thereof, wherein
the smaller diameter portion, onto which the compression ring is fitted, and at least a portion of the body portion are accommodated within the lens sleeve.

8. An optical connector according to claim 4, wherein the body portion of the ferrule is press-fitted into the lens sleeve, whereby the lens sleeve is fixed to the ferrule.
